(19) United States
(12) Patent Application Publication
(10) Pub. No.: US 2008/0163831 A1
(43) Pub. Date: Jul. 10, 2008

(54) Illuminated pet clothing

(76) Inventor: John Romanuck, Medicine Hat (CA)

Correspondence Address: Jim Helfrich, 200 Chateau St, Sun River, MT, 59483, US

(21) Appl. No.: 11/650,518

(22) Filed: Jan. 8, 2007

(51) Int. Cl. A01K 13/00; A62B 37/00

(52) U.S. Cl. 119/850; 119/859; 119/858

(57) ABSTRACT

A carrier (pet apparel) with at least one light emitting diode (LED) placed in a holder with reflective finish in a concave housing to provide optimal diffusion and candle power for optimal distance and visibility and a power source for powering at least one LED.

### FIELD OF THE INVENTION

The present invention relates to illuminated pet clothing and, more particularly, to a vest equipped with LED lights and high visibility colors.

### BACKGROUND OF THE INVENTION

Pets, especially dogs and cats are typically small and colored in such a manner that causes them to blend in with their natural surroundings. They do not vocalize when called making them difficult to see or find especially in dense vegetation, at night or in other low light and poor visibility conditions. When pets are hard to see they can be injured by oncoming automobiles or lost. In situations where a dog is being used in rescue work it may be imperative to be able to know where that dog is in very adverse conditions. Individuals lost in the outdoors could easily notice a rescue dog off in the distance equipped with an illuminated device as could people in conditions of a fallen building such as what occurred in NY on September 11. People who walk their pets at night are often near the curb and can be difficult to see especially if it is foggy or raining. Pet visibility and location are issues that have been a problem since people first began taking animals as pets.

Other solutions do exist in various forms with varying degrees of success. One such method is brightly colored clothing. Another is a radio tracking collar and yet another solution is a bell attached to the animal.

While all of the other solutions provide some assistance to the problem they typically only solve one small portion of the issue. For example, brightly colored clothing works well in good light, but does not work at all in poor or no light conditions. In rescue work, if a dog were on an opposite hill in the dark the owner would have no idea where the pet was if he depended totally on bright colored clothing. Radio tracking collars identify to the person holding the tracking device where the pet is located but no one else knows. So a lost person may not see the dog that passes nearby and a driver on a dark road may still hit the animal for lack of visibility. A bell will help identify where the pet is located to anyone who is able to hear the sound emitted but those driving an automobile could not hear it or if there are loud sounds or high wind conditions the bell could easily go undetected.

It is therefore an object of the invention to increase the visibility thus the safety of the pet.

It is another object of the invention to provide easier and more reliable location of the pet.

It is another object of the invention to provide location and visibility to more than just the owner of the pet.

It is another object of the invention to provide a low cost reliable source of visibility, safety and location of the pet.

### SUMMARY OF THE INVENTION

In accordance with the present invention, there is provided a carrier (pet apparel) with at least one light emitting diode (LED) placed in a holder with reflective finish in a concave housing to provide optimal diffusion and candle power for optimal distance and visibility and a power source for powering at least one LED.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front perspective view of an illuminated pet vest.

For purposes of clarity and brevity, like elements and components will bear the same designations and numbering throughout the Figures.

### DESCRIPTION OF THE PREFERRED EMBODIMENT

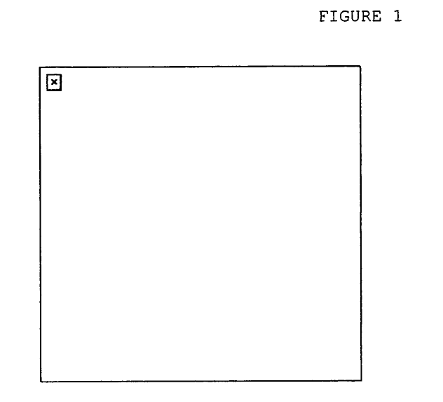

FIG. 1 is a front perspective view of an illuminated pet vest.

Referring now to FIG. 1, in a preferred embodiment of the present invention, light emitting diode 12 (LED'S) are placed in a holder with a reflective backing to provide a visible light. Powered by a DC power source 24 and attached to a reflective strip that is in turn attached to a fabric 10 configured to fit various size animal pet bodies securable to said pet by means of a securing strap 18 and strap fastener 20. A wire harness 22 connects the power source 24 with at least one LED through an on off switch 16.

In one preferred embodiment the reflective tape 14 would be attached to the fabric 10 by stitching 28 though sewing. In another embodiment it may be glued or riveted. Trim 26 may be placed upon the Fabric 10 edges in a preferred embodiment to prevent fraying of the fabric 10 and increase strength.

In this preferred embodiment LED's are powered by a small conventional battery such as a CR2032 lithium conveniently and unobtrusively mounted in a small pocket 30 under the pet apparel. It is understood that the described embodiment of LED′, reflective tape 14, power source 24 and other materials is illustrative only and not intended to be exhaustive and that variations are expected to fit the various sizes and shapes of pets.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An illuminated pet clothing for increased visibility of pets in normal, low light or poor visibility conditions, comprising: means for conforming to the pets body and serving as a carrier for the inventions components;
means for emitting light to provide greater visibility of the pet;
means for increasing visibility of the pet through the reflection of light;
means for securing the apparel to the pet;
means for securing the fastener straps to each other; and
means for providing power to the LED's.

2. The illuminated pet clothing in accordance with claim 1, wherein said means for conforming to the pets body and serving as a carrier for the inventions components comprises a flexible, formable, durable, resilient fabric.

3. The illuminated pet clothing in accordance with claim 1, wherein said means for emitting light to provide greater visibility of the pet comprises a luminescent light emitting diode.

4. The illuminated pet clothing in accordance with claim 1, wherein said means for increasing visibility of the pet through the reflection of light comprises a light reflective, flexible, durable, attachable reflective tape.

5. The illuminated pet clothing in accordance with claim 1, wherein said means for securing the apparel to the pet comprises a formable, flexible, attachable securing strap.

6. The illuminated pet clothing in accordance with claim 1, wherein said means for securing the fastener straps to each other comprises a durable, securable strap fastener.

7. The illuminated pet clothing in accordance with claim 1, wherein said means for providing power to the LED's comprises an energy provider, compact, replenishable power source.

8. An illuminated pet clothing for increased visibility of pets in normal, low light or poor visibility conditions, comprising: a flexible, formable, durable, resilient fabric, for conforming to the pets body and serving as a carrier for the inventions components;
a luminescent light emitting diode, for emitting light to provide greater visibility of the pet;
a light reflective, flexible, durable, attachable reflective tape, for increasing visibility of the pet through the reflection of light;
a formable, flexible, attachable securing strap, for securing the apparel to the pet;
a durable, securable strap fastener, for securing the fastener straps to each other; and
an energy provider, compact, replenishable power source, for providing power to the LED's.

9. An illuminated pet clothing for increased visibility of pets in normal, low light or poor visibility conditions, comprising: a flexible, formable, durable, resilient fabric, for conforming to the pets body and serving as a carrier for the inventions components;
a luminescent light emitting diode, for emitting light to provide greater visibility of the pet;
a light reflective, flexible, durable, attachable reflective tape, for increasing visibility of the pet through the reflection of light;
a formable, flexible, attachable securing strap, for securing the apparel to the pet;
a durable, securable strap fastener, for securing the fastener straps to each other; and
an energy provider, compact, replenishable power source, for providing power to the LED's.
